(19) United States
(12) Patent Application Publication
(10) Pub. No.: US 2013/0036360 A1
(43) Pub. Date: Feb. 7, 2013

(54) WIRELESS AUDIENCE RESPONSE DEVICE

(71) Applicant: Jonathan A. HALLSTEN, Barberton, OH (US)

(72) Inventor: Jonathan A. HALLSTEN, Barberton, OH (US)

(73) Assignee: TURNING TECHNOLOGIES, LLC, Youngstown, OH (US)

(21) Appl. No.: 13/195,545

(22) Filed: Aug. 1, 2011

(51) Int. Cl. G06F 3/048

(52) U.S. Cl. 715/738

(57) ABSTRACT

An audience response device is configured to communicate wirelessly in an audience response system. The device includes a display configured to display a question identifier and a user input interface configured to receive a user selection. The device further includes a processor operably connected to the display and to the user input interface, and configured to receive data representing the user selection. The device further includes a transceiver operably connected to the processor and configured to wirelessly transmit signals including a signal encoding data representing the user response to the question. The device further includes a logic operably connected to the display and the processor and configured to cause the display to display indications regarding the audience response session, a question, a sequence of questions, and so on.

### FIELD OF THE INVENTION

The present application relates to an audience response system. More particularly, the present application relates to a wireless audience response device.

### BACKGROUND

Audience response systems are used in classroom settings, corporate meetings, or in other gatherings to communicate responses to questions.

Audience response systems commonly incorporate one or more bases and a plurality of response devices. The response devices receive responses to questions in the form of user selections on a keypad. The response devices transmit wireless signals encoding the user selections to the base units or host computers.

Conventional audience response devices have been used in combination with external displays such as overhead projectors or onboard displays that lacked audience response session and question information useful to a user when providing answers to audience response questions.

### SUMMARY OF THE INVENTION

An audience response device is configured to communicate wirelessly in an audience response system. The device includes a display configured to display a question identifier and a user input interface configured to receive a user selection. The device further includes a processor operably connected to the display and to the user input interface, and configured to receive data representing the user selection. The device further includes a transceiver operably connected to the processor and configured to wirelessly transmit signals including a signal encoding data representing the user response to the question. The device further includes a logic operably connected to the display and the processor and configured to cause the display to display indications regarding the audience response session, a question, a sequence of questions, and so on.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a schematic of an exemplary audience response system.

FIG. 2 illustrates a front view of an exemplary embodiment of a wireless audience response device.

FIG. 3 illustrates an exemplary block diagram illustrating components of a wireless audience response device.

FIG. 4 illustrates an embodiment of the audience response device.

FIG. 5 illustrates an embodiment of the audience response device.

FIG. 6 illustrates an embodiment of the audience response device.

FIG. 7 illustrates an embodiment of the audience response device.

FIG. 8 illustrates an embodiment of the audience response device.

FIG. 9 illustrates an embodiment of the audience response device.

FIG. 10 illustrates a flow chart for an exemplary method for a response device in an audience response system having a plurality of response devices.

FIG. 11 illustrates a flow chart for an exemplary method for a response device in an audience response system having a plurality of response devices.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Data communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“Soft key,” as used herein, is a button or other user input interface on a device that is programmable to invoke any of a number of functions rather than being associated with a single fixed function or a fixed set of functions.

“User,” as used herein, includes but is not limited to one or more persons, software, computers or other devices, or combinations of these.

“Audience response system,” as used herein, includes but is not limited to systems for interaction between audience members and an entity or entities that collect responses from the audience members. Audience members may be collocated or remote from each other or from an entity collecting the responses. Audience response systems may be used in conjunction with presentation software or may be used without presentation software. Audience response systems may take the form of a base as the entity collecting the responses and wired or wireless devices as the means for users to select their responses to the questions presented. Audience response systems may also take the form of interactive whiteboards where a whiteboard may be used as the means for users to select their responses to the questions presented.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

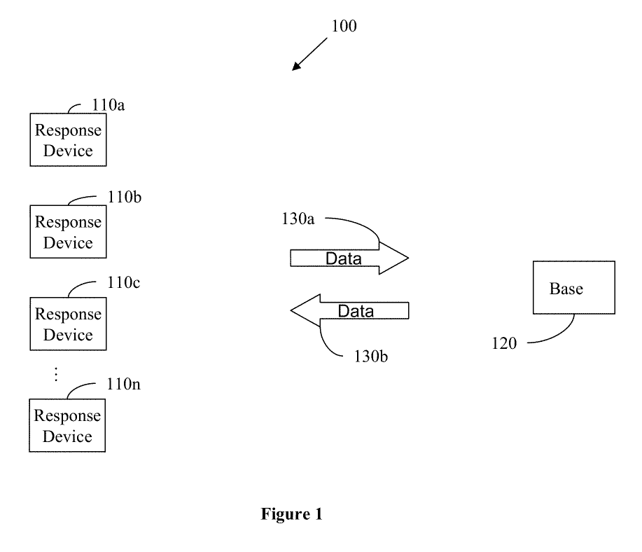

FIG. 1 illustrates a schematic of an exemplary audience response system 100. System 100 includes a plurality of response devices 110a-n. Although four response devices are shown, it should be understood that an audience response system may have as few as one response device or as many as hundreds, or even thousands, of response devices. The response devices may be handheld devices, or may be embedded in a stationary object, such as a chair or desk. The response devices may also be any other devices capable of communicating in an audience response system such as computers (e.g. laptop, PC, tablet, and so on), mobile phones, smart phones, etc. The response devices may be dedicated devices or may be multi-task devices.

The system 100 also includes at least one base 120. The base 120 receives data 130a from the response devices 110a-n and the base 120 transmits data 130b to the response devices 110a-n. The base 120 may be a computer (e.g. laptop, PC, tablet, and so on), multiple computers, a device connected to a computer, a device independent from a computer, combinations thereof, and so on. Although a single base is shown, it should be understood that an audience response system may include multiple bases. In systems with multiple bases, each base may be configured to communicate with preselected response devices. Alternatively, each base may be configured to communicate with any response device. Additionally, in a system with multiple base, each base may be configured to communicate with one or more of the other bases in the system.

In the illustrated embodiment, the response devices 110a-n and the base 120 communicate data 130a-b wirelessly. In one embodiment, the response devices 110a-n and the base 120 transmit and receive radio frequency (RF) signals encoding the data. In another embodiment, the response devices 110a-n and the base 120 transmit and receive infrared (IR) signals encoding the data.

The audience response system 100 may be employed for various audience response sessions. An audience response session may be a lecture or other presentation, in which the presenter asks questions or feedback is otherwise elicited from audience members. An audience member may then use a response device 110 to provide a response. Another example of an audience response session is an assessment that may be moderated by a proctor. The assessment is a test or an evaluation, such as a scholastic test, and admission test, a job evaluation, an employment test, a psychiatric evaluation, surveys, or other tests and evaluations. The assessment includes numbered questions that may be provided on paper or displayed by other means, such as by an overhead projector or digital display, as well as questions that are audibly presented. The use of the audience response system for an assessment as described above may be referred to as a “high stakes” application.

In one embodiment of use in a high stakes application, the response device 110 transmits each answer to the base unit 120 as it is selected. If the user changes an answer to a question already answered, the answer change is transmitted to the base unit. In an alternative embodiment of use in a high stakes application, the response device 110 locally stores each answer. The stored answers are then sent to the base unit 120 in response to a “send” command. The send command may be made by the user or it may be transmitted from the base unit 120.

While this disclosure is directed primarily towards high stakes applications, it should be understood that the audience response system 100 may be employed in both lectures and presentations, as well as in high stakes applications.

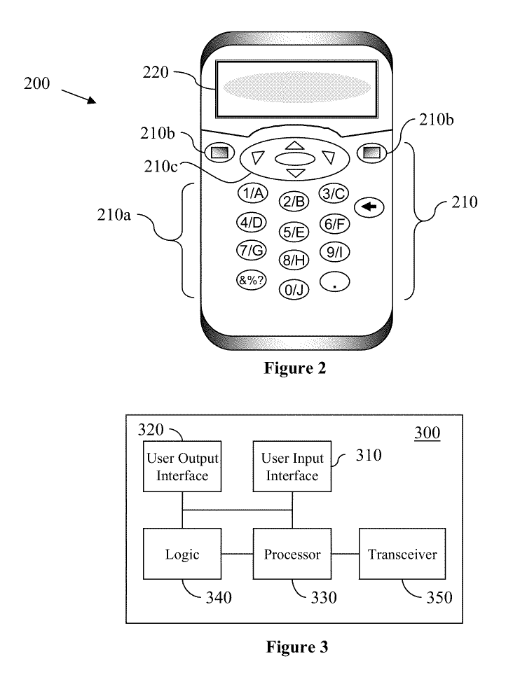

FIG. 2 illustrates a front view of an exemplary embodiment of a wireless audience response device 200. The response device 200 is an exemplary embodiment of the response devices 110 shown in FIG. 1. The response device 200 communicates wirelessly in an audience response system having a plurality of response devices, such as system 100 described above. The response device 200 includes a user input interface 210 and a display 220. The user input interface 210 is illustrated as a keypad, however the user input interface 210 could be one or a combination of input interfaces known in the art (e.g., touch screens, dials, knobs, click wheels, roller balls, roller pads, and so on).

In the illustrated embodiment, the user input interface 210 includes alpha-numeric keys 210a, soft keys 210b, and arrow keys 210c. These keys may be used by a user to enter information, including responses to audience response questions during a polling or test session. A user may also use the user input interface 210 to enter other types of information, including log-in or sign-in information, setup information, administrative information regarding a polling or testing session, and so on. In other embodiments, the user input interface 210 may include keys in formats other than alpha-numeric, arrow, and soft keys. Alternatively, the user input interface 210 may include a touch screen or a slide meter.

In the illustrated embodiment, the display 220 is a liquid crystal display (LCD) configured to display various information related to audience response sessions (e.g. unit ID, user ID, question ID, response entered, response received, time left in the session, time left to answer a question, and so on). The display 220 may also display device status information (e.g. on/off, battery life, transmission channel, and so on). In alternative embodiments, other output devices may be employed instead of an LCD (e.g., touch screens, LED screens, and so on).

FIG. 3 illustrates an exemplary block diagram illustrating components of a wireless audience response device 300. It should be understood that the device 300 may be the same as device 200 of FIG. 2. However, device 300 is not limited to such a configuration.

Device 300 includes a user input interface 310 configured to receive user selections. A user selection may take the form of a key press in alpha-numeric keys, arrow keys, and soft keys such as those included in the user input interface 210 described above. In other embodiments, user selections may take the form of selections in other types of user input interfaces (e.g., pointing device, wheel, slide meter, combinations thereof, and so on). The device 300 further includes a user output interface 320. The user output interface 320 may take the form of a display such as display 220 discussed above. The user output interface 320 may also take the form of various other user output interfaces (e.g. LED displays, LCD, combinations thereof, and so on).

The device 300 also includes a processor 330. The processor 330 operably connects to the user input interface 310 and the user output interface 320. The processor 330 receives from the user input interface 310 data representing the user selections. The device 300 further includes a logic 340, which operably connects to the user output interface 320 and to the processor 330. The logic 340 controls the user output interface 320 and causes the user output interface 320 to display question identifiers (as defined below) and other indicators in accordance with the disclosed invention.

The device 300 also includes a transceiver 350 which operably connects to the processor 330. The transceiver 350 transmits wireless signals including signals encoding data representing user responses to the audience response questions. The transceiver 350 also receives wireless signals. Although the transceiver 350 is illustrated as separate from the processor 330, it should be understood that the transceiver 350 and processor 330 may be part of the same component. In an alternative embodiment (not shown), the transceiver 350 may be implemented as a discrete transmitter and a separate receiver.

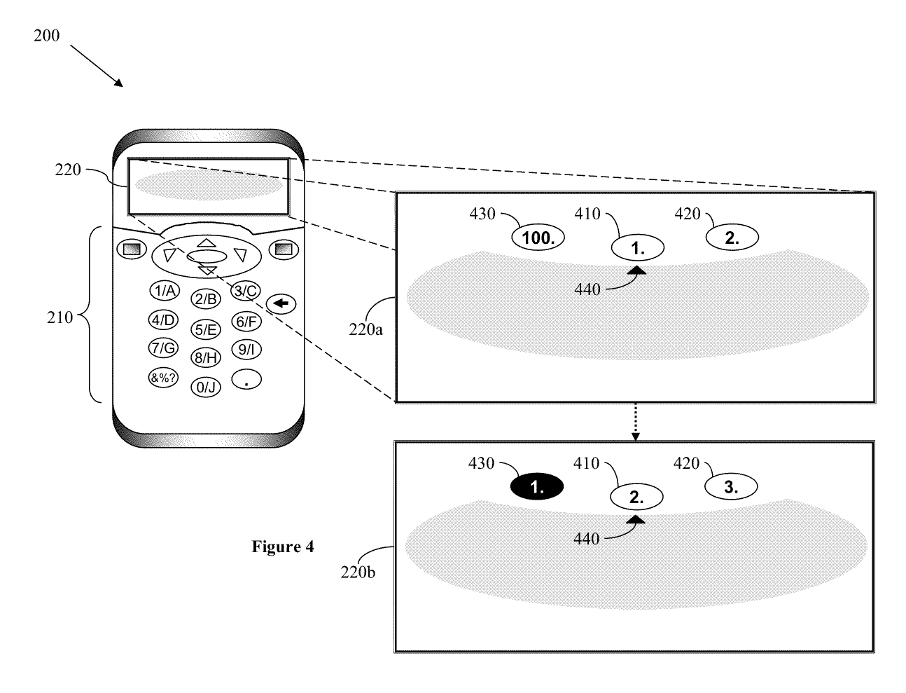

FIG. 4 illustrates an embodiment of the audience response device 200 including a display 220 that has been further illustrated in detailed views for ease of illustration. The detailed views show a display 220a in a first exemplary display mode and display 220b in a second exemplary display mode. It should be understood that the display 220 may have any number of display modes and that the terms “first” and “second” in this context do not connote any particular sequence, but are merely used to distinguish the illustrated modes.

The display 220a displays question identifiers 410, 420, and 430. A question identifier uniquely identifies a question from a sequence of questions. In the illustrated embodiment, an audience response session or exam includes 100 questions. For each of the 100 questions a question identifier uniquely identifies the question. In the illustrated example, the question identifier 410 identifies the first question as (1.), the question identifier 420 identifies the second question as (2.), and the question identifier 430 identifies the final question as (100.). While the illustrated embodiment shows 100 questions, it should be understood that this is merely exemplary and that the audience response system disclosed herein may be used for any number of questions.

A user would select an answer to a question when that question is queued and the display 220a identifies the question as the current question. In the illustrated embodiment, question (1.) is identified as the current question by means of its question identifier 410 being displayed just above the current question indicating arrow 440. If a user were to make a selection on the user input interface 210 while question (1.) is indicated as the current question, the selection would correspond to question (1.). Possible user selections include an answer to the current question and skipping of the current question. Other possible user selections include flagging a question, clearing a flag, deleting an answer, or sending answers.

In one embodiment, if, for example, the user knows the answer to the current question, the user would select the answer by making a selection on the user input interface. Once the user has made the selection, the logic or processor in the device 200 causes the display 220b to indicate that question (1.) has already been answered. The logic further queues the next question, question (2.), as the current question and causes the display 220b to indicate that question (2.) is now the current question. In one embodiment, the display 220b indicates that question (1.) has already been answered by displaying the question identifier 430 now associated with question (1.) graphically different than question identifiers for questions that have not been answered (e.g., 420). This is shown in FIG. 4 with a darkened oval. However, it should be understood that any graphic may be employed to distinguish an answered question from an unanswered question.

In another embodiment (not illustrated), the user may not know the answer to the current question. The user may select to skip the current question so that another question may be queued for the user to make selections corresponding to the other question. In one embodiment, a user selects the one of the soft keys 210b to select a “jump to question” option, and the user may then identify a specific question to answer. Alternatively, a user may use a soft key 210b or an arrow key 210c to advance to the next question without answering the current question. Alternatively, a user may use a soft key 210b or an arrow key 210c to advance to the next unanswered question or to the next flagged question, without answering the current question.

If the user has made the selection of skipping question (1.) and advancing to the next question, the result is similar to that shown by display 220b. The device 200 queues question (2.) as the current question and the display 220b indicates that question (2.) is now the current question. However, in this circumstance, the display also indicates that question (1.) has not been answered. In one embodiment, the display (not illustrated) indicates that a question has not been answered by displaying question identifiers associated with answered questions graphically different than question identifiers for questions that have been answered.

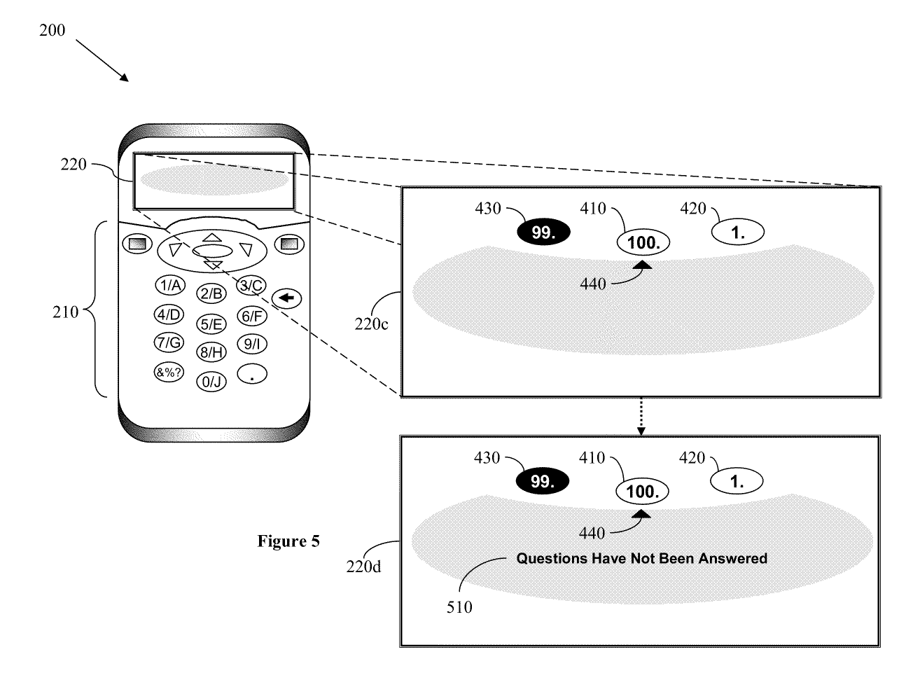

FIG. 5 illustrates an embodiment of the audience response device 200 including detail views of displays 220c and 220d for ease of illustration.

In one embodiment, where the current question is the final question in the sequence of questions, if the user were to make a selection such as answering the current question, skipping of the current question, or otherwise indicate that the user is finished making user selections, the display 220 displays an indication that at least one question from the sequence of questions remains unanswered. This would serve as a reminder to the user that although the user just made a user selection corresponding to the final question in the sequence of questions, other questions in the sequence of questions are yet to be answered.

In the illustrated embodiment, the display 220c displays the current question as question (100.), the final question in the sequence. If the user, for example, selected to skip question (100.) or the user indicated that the user was finished making user selections (e.g., the user has completed the exam), the display 220d displays an indication 510 that at least one question from the sequence of questions remains unanswered. In other embodiments (not illustrated), the indication 510 may take forms other than that illustrated (e.g., display 220 may display a symbol indicating at least one question from the sequence of questions remains unanswered, display 220 may blink to indicate at least one question from the sequence of questions remains unanswered, and so on).

Alternatively, or in addition to the scenario described above, if the user attempts to send answers to the base 120 but has not answered every question in the assessment, the user will be alerted that unanswered questions remain.

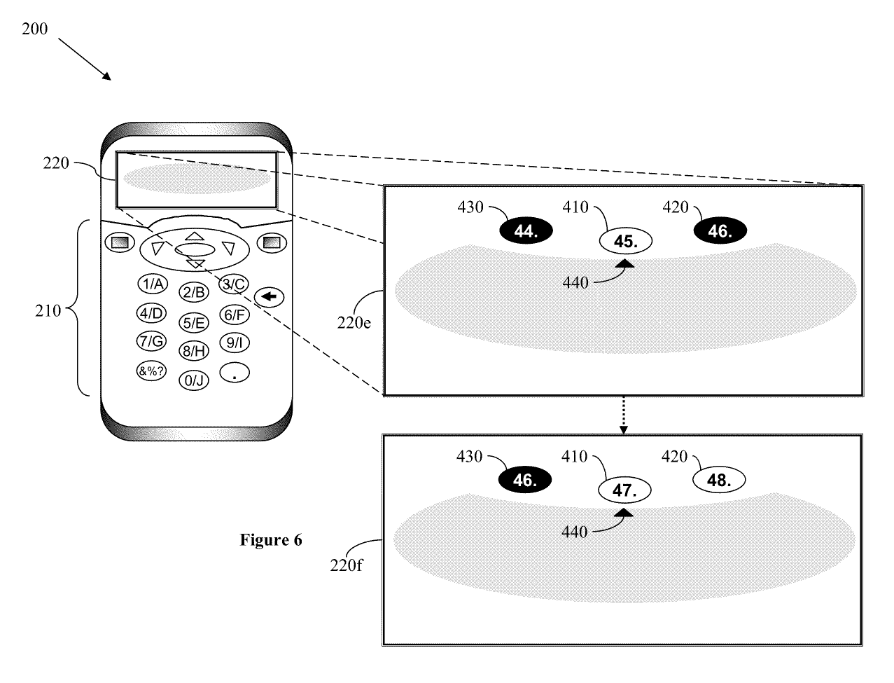

FIG. 6 illustrates an embodiment of the audience response device 200 including detail views of displays 220e and 220f for ease of illustration.

In one embodiment, upon a user selection corresponding to a user response to the current question or skipping of the current question, the logic skips at least one answered question in the sequence of questions, queues an unanswered question from the sequence of questions, and causes the display to display a question identifier corresponding to the unanswered question.

In the illustrated embodiment, the display 220e displays the question identifier 410 that identifies the current question as (45.) and as a question that has not been answered. The user selects either an answer to or skipping of the current question (45.) by making a selection on the user input interface 210. Once the user has made the selection, the logic in the device 200 queues the next unanswered question as the current question—not question (46.), the next question in the sequence of questions. Therefore, the logic causes the display 220f to indicate that question (47.), the next unanswered question in the sequence of questions, is now the current question. The logic skipped question (46.) because the question had already been answered.

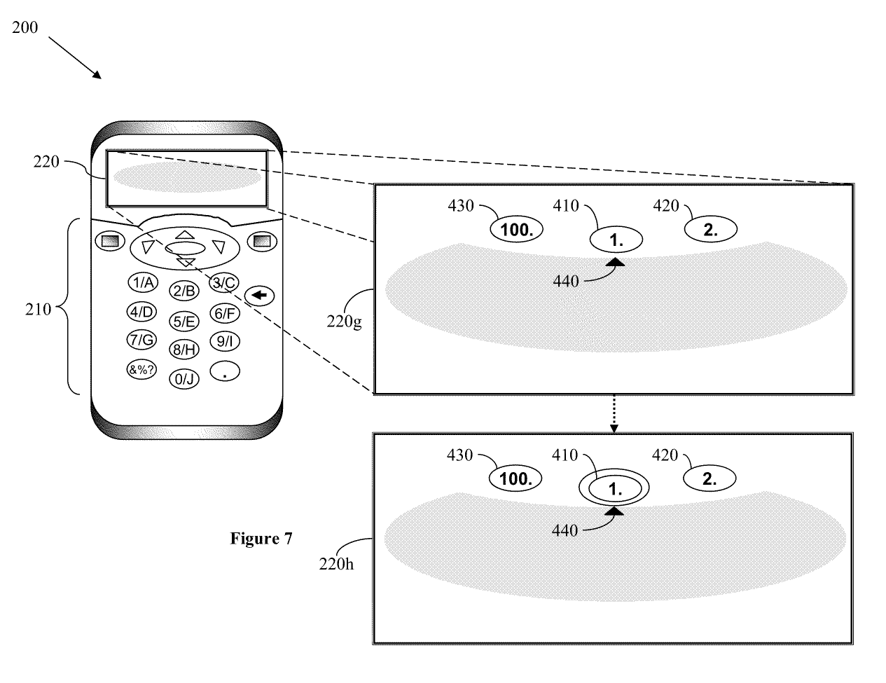

FIG. 7 illustrates an embodiment of the audience response device 200 including detail views of displays 220g and 220h for ease of illustration.

In addition to the user selections described above, another possible user selection include flagging of the current question. In one embodiment, the user may not know the answer to the current question (1.) in display 220g or the user may want to mark the current question (1.) to remember to come back to the question at a later time. The user may select to flag the current question (1.). The user may then answer or skip the current question (1.) so that another question may be queued for the user to make selections corresponding to the other question. In one embodiment, flagging of the current question causes the logic to automatically queue the next question.

Upon the user selecting to flag the current question and the processor receiving data representing the user selection, the logic in device 200 modifies data associated with the question to record that the question has been flagged. In one embodiment, modifying data associated with the question to record that the question has been flagged includes modifying a field corresponding to the question in a data store.

Once the user has made the selection of flagging the current question, the display 220h indicates that the question has been flagged. In the illustrated embodiment, the display 220h indicates that question (1.) has been flagged by displaying its question identifier graphically different than question identifiers for questions that have not been flagged. In other embodiments (not shown), the display indicates that a question has been flagged by means other than by displaying its question identifier graphically different than question identifiers for questions that have not been flagged. While FIG. 7 shows an oval to indicate that a question has been flagged, it should be understood that any graphical identifier may be employed.

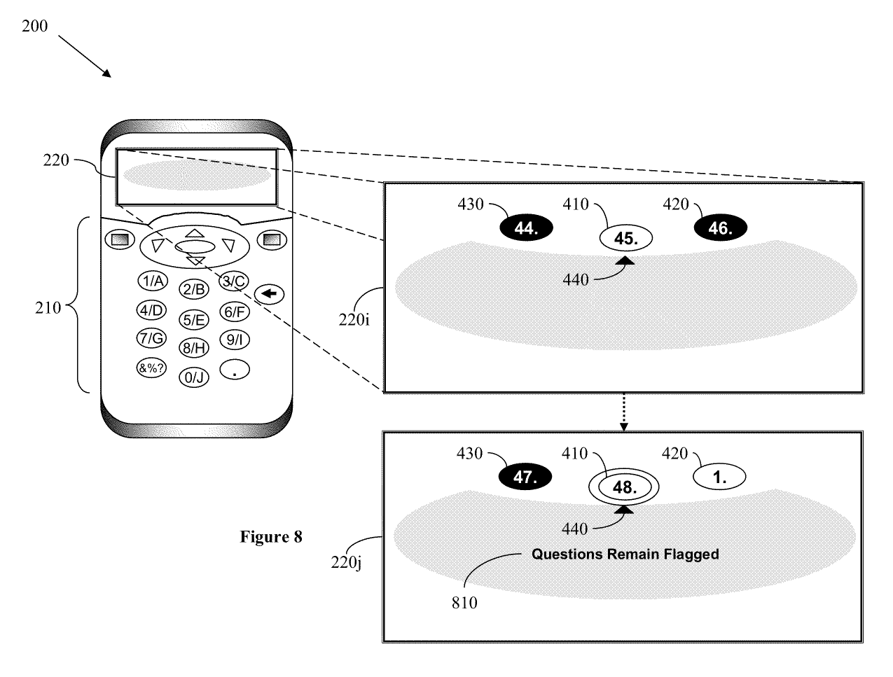

FIG. 8 illustrates an embodiment of the audience response device 200 including a detail view of displays 220i and 220j for ease of illustration.

In one embodiment, upon a user selection corresponding to a user response to the current question or skipping of the current question, the logic skips at least one non flagged question in the sequence of questions, queues a flagged question from the sequence of questions, and causes the display to display a question identifier corresponding to the flagged question.

In the illustrated embodiment, the display 220i displays the question identifier 410 that identifies the current question as (45.). In one embodiment, the user selects either an answer to or skipping of the current question (45.) by making a selection on the user input interface 210. Once the user has made the selection, the logic in the device 200 queues as the current question, not question (46.), the next question in the sequence of questions, but the next flagged question in the sequence. Therefore, the logic causes the display 220j to indicate that question (48.), the next flagged question in the sequence of questions, is now the current question. The logic skipped questions (46.) and (47.) because the questions were not flagged.

In one embodiment, where the current question is the final question in the sequence of questions, upon the processor receiving the data representing the user selection corresponding to the skipping of the question currently queued or the user selection corresponding to the user response to the question currently queued, the logic causes the display 220j to display an indication 810 that at least one question from the sequence of questions remains flagged.

In the illustrated embodiment, the display 220j displays question (48.) as the current question. Question (48.) is also the final question in the sequence of questions. If the user made a selection corresponding to, for example, skipping of the question (48.), the logic causes the display 220j to indicate that at least one question from the sequence of questions remains flagged by displaying the indication 810. In other embodiments (not illustrated), the indication 810 may take forms other than those illustrated (e.g., display 220 may display a symbol indicating that at least one question from the sequence of questions remains flagged, display 220 may blink to indicate that at least one question from the sequence of questions remains flagged, and so on).

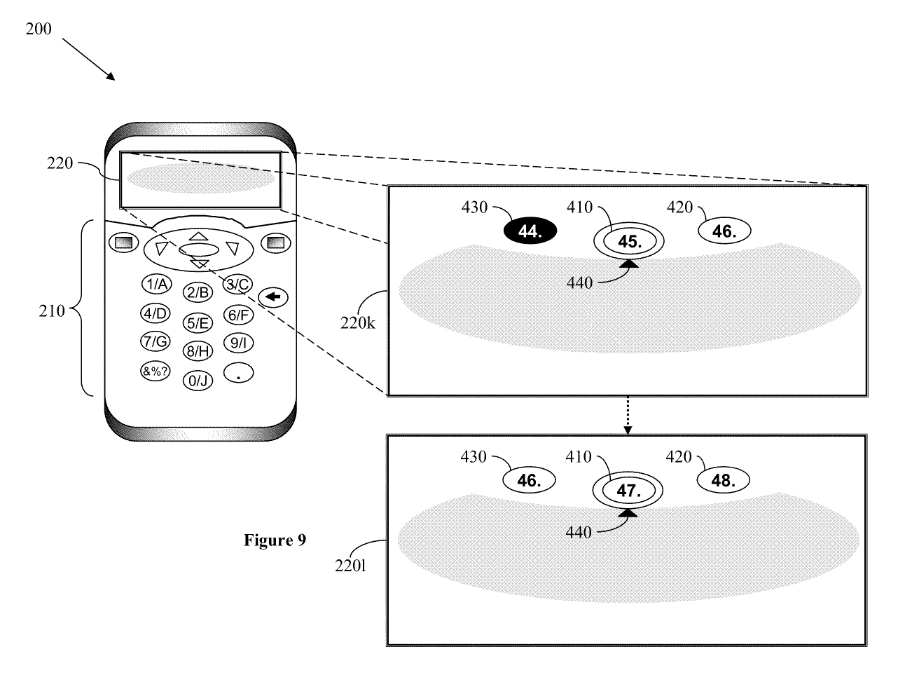

FIG. 9 illustrates an embodiment of the audience response device 200 including detail views of displays 220k and 220l for ease of illustration.

In one embodiment, upon a user selection corresponding to a user response to the current question or skipping of the current question, the logic skips at least one non flagged question in the sequence of questions, queues a flagged question from the sequence of questions, and causes the display 200 to display a question identifier corresponding to the flagged question.

In the illustrated embodiment, the display 220k displays the question identifier 410 that identifies the current question as (45.) and as a question that has been flagged. In one embodiment, the user selects either an answer to or skipping of the current question (45.) by making a selection on the user input interface. Once the user has made the selection, the logic in the device 200 queues as the current question, not question (46.), the next question in the sequence of questions, but the next flagged question in the sequence. Therefore, the logic causes the display 220l to indicate that question (47.), the next flagged question in the sequence of questions, is now the current question. The logic skipped question (46.) because the question had not been flagged.

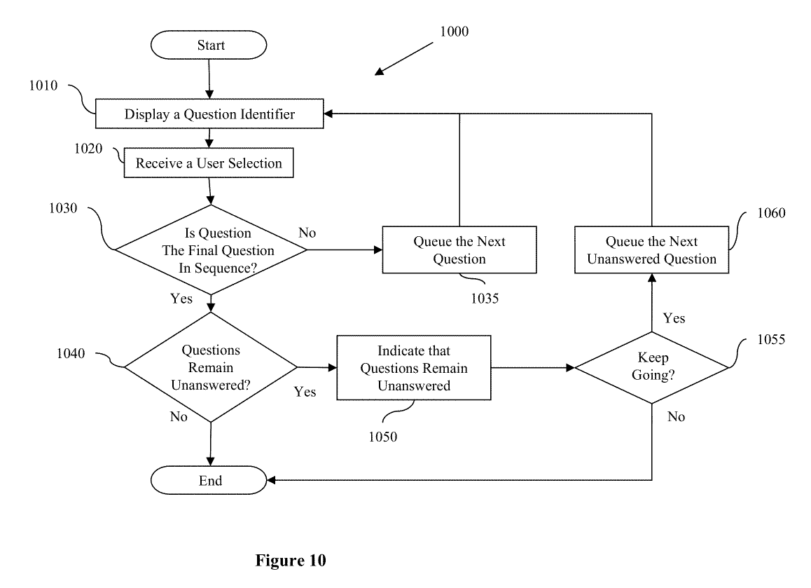

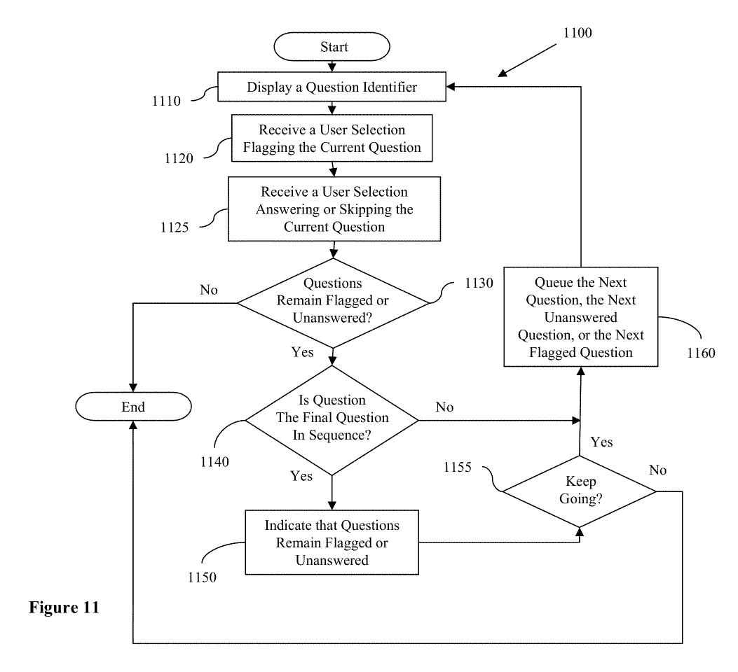

Example methods may be better appreciated with reference to the flow diagrams of FIGS. 10 and 11. For purposes of simplicity of explanation, the illustrated methodologies are shown and described as a series of blocks. However, the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional blocks that are not illustrated.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform the methods of FIGS. 10 and 11. While the methods are described as provided on a computer-readable medium, it is to be appreciated that other example methods described herein can also be provided on a computer-readable medium.

While FIGS. 10 and 11 illustrate various actions occurring in serial, it is to be appreciated that various actions illustrated in FIGS. 10 and 11 could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 10 illustrates a flow chart for an exemplary method 1000 for a response device in an audience response system having a plurality of response devices. At 1010, the response device displays a question identifier that uniquely identifies a current question from a sequence of questions. At 1020, the response device receives a user selection corresponding to the current question. User selections include a response to the current question and skipping of the current question. In one embodiment, the response device indicates that a question has been answered by graphically displaying the question identifier corresponding to the question that has been answered differently than a question identifier corresponding to a question that has not been answered.

At 1030, if the question is not the final question of the sequence, the next question is queued at 1035. If the question is the final question of the sequence, it is determined whether any questions from the sequence of questions remain unanswered at 1040. If no questions from the sequence of questions remain unanswered, the sequence of questions have been completed. If questions from the sequence of questions remain unanswered, at 1040, if the question was the final question in the sequence of questions or if the user in error indicates via a user selection that the user has finished making selections to the questions, indicate that questions remain unanswered at 1050. At 1055, if the user chooses to continue making selections to the questions, at 1060, queue in the next question or the next unanswered question, and return to 1010.

FIG. 11 illustrates a flow chart for an exemplary method 1100 for a response device in an audience response system having a plurality of response devices. At 1110, the response device displays a question identifier that uniquely identifies a current question from a sequence of questions. At 1120, the response device receives a user selection flagging the current question. In one embodiment, the response device indicates that a question has been flagged by graphically displaying the question identifier corresponding to the question that has been flagged differently than a question identifier corresponding to a question that has not been flagged. At 1125, the response device receives a user selection corresponding to answering or skipping of the current question. In one embodiment, the user may flag a question that is answered or a question that is unanswered. In an alternative embodiment, receiving a user selection flagging the current question automatically skips the current question and therefore, in such an embodiment, step 1125 would not be necessary.

At 1130, if no questions from the sequence of questions remain flagged or unanswered, the sequence of questions have been completed. If questions from the sequence of questions remain flagged or unanswered, at 1140, if the question was the final question in the sequence of questions, indicate that questions remain flagged or unanswered at 1150. At 1155, if the user chooses to continue making selections to the questions, at 1160, queue in the next question, the next unanswered question, or the next flagged question, and return to 1110.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A response device configured to communicate wirelessly in an audience response system, the device comprising:
a display configured to display a question identifier that uniquely identifies a question from a sequence of questions including at least a first question and a final question;
a user input interface configured to receive a user selection corresponding to one of skipping of the question and a user response to the question;
a processor operably connected to the display and to the user input interface, and configured to receive data representing the user selection corresponding to the one of the skipping of the question and the user response to the question;
a logic operably connected to the display and the processor, where the question is the final question in the sequence of questions, and where the logic is configured to cause the display to display an indication that at least one question from the sequence of questions remains unanswered upon the processor receiving the data representing the user selection corresponding to the one of the skipping of the question and the user response to the question; and
a transceiver operably connected to the processor and configured to wirelessly transmit signals including a signal encoding data representing the user response to the question.

2. The response device of claim 1, where the logic is further configured to cause the display to graphically indicate whether one or more of the questions from the sequence of questions have been answered or remain unanswered by displaying a question identifier identifying a question that has been answered graphically differently than a question identifier identifying a question that has not been answered.

3. The response device of claim 1, where the logic is further configured to, upon the processor receiving the data representing the user selection corresponding to the one of the user response to the question and skipping of the question, skip at least one answered question in the sequence of questions, queue an unanswered question from the sequence of questions for the response device to receive a response to the unanswered question, and cause the display to display a question identifier corresponding to the unanswered question.

4. The response device of claim 1, where the user input interface is further configured to receive a user selection corresponding to flagging of the question, and where the logic is further configured to modify data associated with the question to record that the question has been flagged upon the processor receiving data representing the user selection corresponding to the flagging of the question.

5. A response device configured to communicate wirelessly in an audience response system, the device comprising:
a display configured to display a question identifier, where question identifiers uniquely identify questions from a sequence of questions including at least a first question and a final question, and where the displayed question identifier corresponds to a question currently queued for the response device to receive a response to the question;
a user input interface configured to receive a user selection;
a processor operably connected to the display and to the user input interface, and configured to receive data representing the user selection;
a logic operably connected to the display and the processor, where the logic is configured to cause the display to graphically indicate whether one or more of the questions from the sequence of questions have been answered or remain unanswered upon the processor receiving the data representing the user selection; and
a transceiver operably connected to the processor and configured to transmit signals including a signal encoding data representing the user response.

6. The device of claim 5, where the user selection corresponds to one of:
a user response to the question currently queued,
skipping of the question currently queued, and
an indication that the user is finished making selections.

7. The device of claim 5, where the logic is further configured to cause the display to graphically indicate whether one or more of the questions from the sequence of questions have been answered or remain unanswered by displaying a question identifier identifying a question that has been answered graphically differently than a question identifier identifying a question that has not been answered.

8. The device of claim 5, where the question currently queued is the final question in the sequence of questions, and where the logic is further configured to cause the display to display an indication that at least one question from the sequence of questions remains unanswered upon the processor receiving the data representing the user selection.

9. The device of claim 5, where the logic is further configured to, upon the processor receiving the data representing the user selection, skip at least one answered question in the sequence of questions, queue an unanswered question in the sequence of questions for the response device to receive a response to the unanswered question, and cause the display to display a question identifier corresponding to the unanswered question.

10. The device of claim 5, where the user input interface is further configured to receive a user selection corresponding to flagging of the question, where the processor is further configured to receive data representing the user selection corresponding to the flagging of the question currently queued, and where the logic is further configured to upon the processor receiving the data representing the user selection corresponding to the flagging of the question currently queued, modify data associated with the question currently queued to record that the question currently queued has been flagged.

11. A response device configured to communicate wirelessly in an audience response system, the device comprising:
a display configured to display a question identifier, where question identifiers uniquely identify questions from a sequence of questions including at least a first question and a final question, and where the displayed question identifier corresponds to a question currently queued for the response device to receive a response to the question;
a user input interface configured to receive a user selection corresponding to one of skipping of the question currently queued and a user response to the question currently queued;
a processor operably connected to the display and to the user input interface, and configured to receive data representing the user selection corresponding to the one of the skipping of the question currently queued and the user response to the question currently queued;
a transceiver operably connected to the processor and configured to transmit signals including a signal encoding data representing the user response to the question currently queued; and
a logic operably connected to the display and the processor and configured to, upon the processor receiving the data representing the user selection corresponding to the one of the user response to the question currently queued and skipping of the question currently queued, skip at least one answered question in the sequence of questions, queue an unanswered question from the sequence of questions for the response device to receive a response to the unanswered question, and cause the display to display a question identifier corresponding to the unanswered question.

12. The device of claim 11, where the logic is further configured to cause the display to graphically indicate whether one or more of the questions from the sequence of questions have been answered or remain unanswered by displaying a question identifier identifying a question that has been answered graphically differently than a question identifier identifying a question that has not been answered.

13. The device of claim 11, where the question currently queued is the final question in the sequence of questions, and where the logic is further configured to cause the display to display an indication that at least one question from the sequence of questions remains unanswered upon the processor receiving the data representing the user selection corresponding to the one of the skipping of the question currently queued and the user response to the question currently queued.

14. The device of claim 11, where the user input interface is further configured to receive a user selection corresponding to flagging of the question, where the processor is further configured to receive data representing the user selection corresponding to flagging of the question currently queued, and where the logic is further configured to upon the processor receiving the data representing the user selection corresponding to the flagging of the question currently queued, modify data associated with the question currently queued to record that the question currently queued has been flagged.

15. A response device configured to communicate wirelessly in an audience response system, the device comprising:
a display configured to display a question identifier, where question identifiers uniquely identify questions from a sequence of questions including at least a first question and a final question, and where the displayed question identifier corresponds to a question currently queued for the response device to receive a response to the question;
a user input interface configured to receive a user selection, where user selections include a user selection corresponding to skipping of the question currently queued, a user selection corresponding to flagging of the question currently queued, and a user selection corresponding to a user response to the question currently queued;
a processor operably connected to the display and to the user input interface, and configured to receive data representing the user selection;
a logic operably connected to the processor and configured to, upon the processor receiving the data representing the user selection corresponding to the flagging of the question currently queued, modify data associated with the question currently queued to record that the question currently queued has been flagged; and
a transceiver operably connected to the processor and configured to wirelessly transmit a signal encoding data representing the user response to the question currently queued upon the processor receiving the data representing the user selection corresponding to the user response to the question currently queued.

16. The device of claim 15, where the question currently queued is the final question in the sequence of questions, and where the logic is configured to, upon the processor receiving the data representing the user selection corresponding to the skipping of the question currently queued or the user selection corresponding to the user response to the question currently queued, cause the display to indicate that at least one question from the sequence of questions remains flagged.

17. The device of claim 15, where the logic is further configured to, upon the processor receiving the data representing the user selection corresponding to the one of the user response to the question currently queued and skipping of the question currently queued, skip at least one question in the sequence of questions that has not been flagged, queue a question from the sequence of questions that has been flagged, and cause the display to display a question identifier corresponding to the question that has been flagged.

18. The device of claim 15, where the logic is further configured to cause the display to graphically indicate whether one or more of the questions from the sequence of questions have been flagged.

19. The device of claim 15, where the logic is further configured to cause the display to graphically indicate whether one or more of the questions from the sequence of questions have been flagged by displaying a question identifier identifying a question that has been flagged graphically differently than a question identifier identifying a question that has not been flagged.

20. The device of claim 15, where the logic is further configured to, upon the processor receiving the data representing the user selection, skip at least one answered question in the sequence of questions, queue an unanswered question from the sequence of questions for the response device to receive a response to the unanswered question, and cause the display to display a question identifier corresponding to the unanswered question.
